(19) United States
(12) Patent Application Publication
(10) Pub. No.: US 2006/0250542 A1
(43) Pub. Date: Nov. 9, 2006

(54) Backlight structure

(75) Inventors: Pang-Hsuan Liu, Taoyuan County (TW); Ko-Chia Kao, Pingtung County (TW)

Correspondence Address: BACON & THOMAS, PLLC, 625 SLATERS LANE, FOURTH FLOOR, ALEXANDRIA, VA, 22314, US

(73) Assignee: AU OPTRONICS CORP., Hsin-Chu (TW)

(21) Appl. No.: 11/241,951

(22) Filed: Oct. 4, 2005

(30) Foreign Application Priority Data
May 4, 2005 (TW) 94114456

(51) Int. Cl. G02F 1/1335

(52) U.S. Cl. 349/61

(57) ABSTRACT

A backlight structure is provided. The backlight structure includes a light guide, a light source module and a reflector. The light guide has a groove which is positioned on one side of the bottom of the light guide. The reflector is disposed below the light guide and extended to the groove for a light mixing zone to be formed in the groove. The light source module corresponds to the groove.

This application claims the benefit of Taiwan application Serial No. 94114456, filed May 4, 2005, the subject matter of which is incorporated herein by reference.

### BACKGROUND OF THE INVENTION

1. Field of the Invention

The invention relates in general to a backlight structure, and more particularly to a backlight structure applied in a liquid crystal display (LCD).

2. Description of the Related Art

Referring to FIG. 1, a light-mixing diagram of a conventional backlight structure is shown. In side type backlight structure 100 applied in the LCD, the backlight source module is normally formed by a number of light sources. For example, a light source 8, a light source 9 and a light source 10 form the light source module. The light source can be a red light emitting diode (LED), the light source 8 can be a red LED, the light source 9 can be a green LED, and light source 10 can be a blue LED. The light emitted from a light outputting surface 7 of light guide 103 to an LCD panel of the LCD must be evenly distributed. Therefore, the light provided by the light sources 8˜10 must be mixed after entering the sidewall 3 of the light guide 103. Consequently, the peripheral part of the light outputting surface 7 becomes a light mixing zone. The LED has a strong directivity, so a longer light-mixing distance is required, reducing the area of the light outputting surface 7. If the backlight structure 100 receives the light from two lateral sides, namely the sidewall 3 and the sidewall 5, the light-mixing distance would become even longer in the light guide, further restricting the display scale of the LCD.

In another conventional backlight structure, the LEDs of various colors are disposed in lateral sides of the light guide, the distance between the LEDs of the same color can be shortened, so that the required length in the light mixing zone can be reduced. However, the length and the width of the light outputting surface are still smaller than the maximum length and maximum width of the light outputting surface of the light guide.

In other conventional backlight module, the light-mixing plate is disposed to mix the light emitted by LEDs of various colors before the light enters the light guide. Despite this backlight structure is capable of effectively enlarge the display area of the light outputting surface, the light efficiency is deteriorated because the light must pass through the light-mixing plate first and then enter the light guide. The manufacturing cost is increased due to an additional manufacturing process of the disposition of the light-mixing plate.

### SUMMARY OF THE INVENTION

It is therefore an object of the invention to provide a backlight structure having a light guide with a cantilever structure. The area of the light outputting surface on the light guide is equal to the sum of the area of the light guide body and the area of the cantilever. Compared with the conventional light guide without having a cantilever structure, the light guide of the invention increases a larger light outputting surface by the light-emitting, area of the cantilever.

The invention achieves the above-identified object by providing a backlight structure. The backlight structure includes a light guide, a light source module and a reflector. The light guide has a groove which is positioned on one side of the bottom of the light guide. The reflector is disposed below the light guide and extended to the groove for a light mixing zone to be formed in the groove. The light source module corresponds to the groove.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Related Art) is a light-mixing diagram of a conventional backlight structure;

FIG. 2A is a three-dimensional diagram of the backlight structure according to a first embodiment of the invention;

FIG. 2B is a side view of the backlight structure according to a first embodiment of the invention;

FIG. 3 is a side view of the backlight structure according to a second embodiment of the invention;

FIG. 4 is a side view of the backlight structure according to a third embodiment of the invention; and

FIG. 5 is a side view of the backlight structure according to a fifth embodiment of the invention.

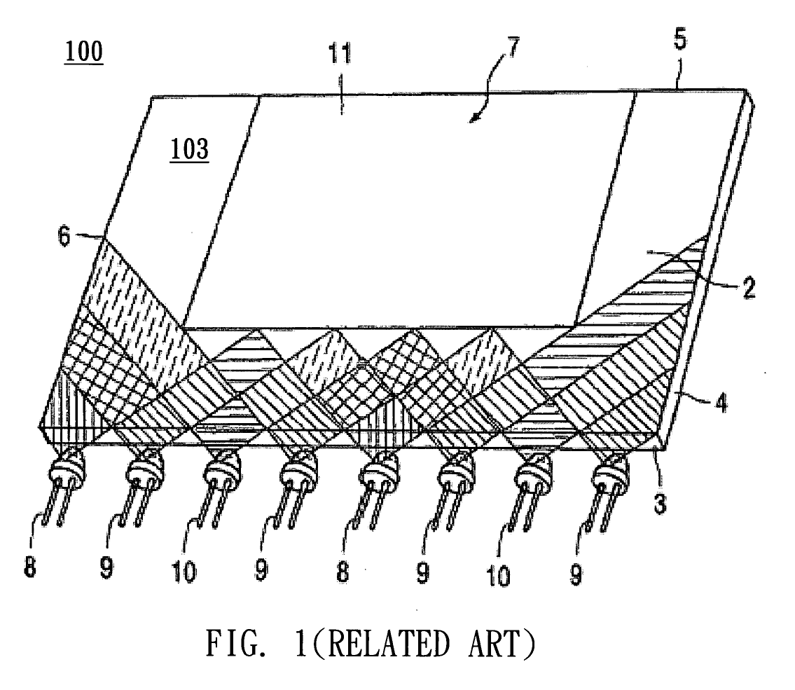

### DETAILED DESCRIPTION OF THE INVENTION

### First Embodiment

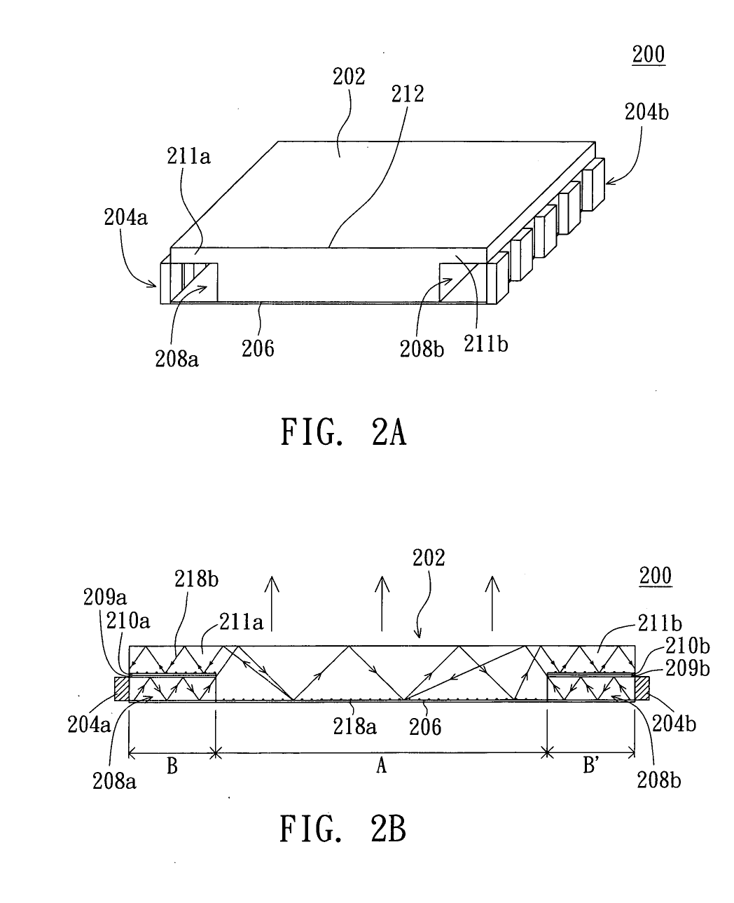

Referring to FIG. 2A, a three-dimensional diagram of the backlight structure according to a first embodiment of the invention is shown. The backlight structure 200 applied in an LCD includes a light guide 202, a first reflector 206, a first light source module 204a and a second light source module 204b. The light guide 202 has a first groove 208a and a second groove 208b respectively positioned on two sides of the bottom of the light guide 202. The first reflector 206 is disposed below the light guide 202 and extended to the first groove 208a and the second groove 208b for a first light mixing zone and a second light mixing zone to be formed on the first groove 208a and the second groove 208b, respectively. A first cantilever 211a and a second cantilever 211b are respectively formed above the first groove 208a and the second groove 208b but below the top surface 212 of the light guide 202.

Referring to both FIG. 2A and FIG. 2B, FIG. 2B is a side view of the backlight structure according to a first embodiment of the invention. When the light generated by the first light source module 204a and the second light source module 204b respectively enter the first groove 208a and the second groove 208b, the light generated by the first light source module 204a mixes in the first light mixing zone and the light generated by the second light source module 204b mixes in the second light mixing zone. The present embodiment of the invention uses the air as a medium to mix the light to become evenly distributed and then enter the light guide 202. When the light enters the light guide 202, part of the evenly distributed light is directly emitted by a number of bottom dot patterns 218a disposed on the bottom of the light guide 202, while another part of the light is reflected by the first reflector 206 to enter the first cantilever 211a and the second cantilever 211b. The first cantilever 211a and the second cantilever 211b, according to a second reflector 210a and a fourth reflector 210b respectively disposed on the bottom of the first cantilever 211a and that of the second cantilever 211b, enable the evenly distributed light to enter the terminal of the cantilever. A third reflector 209a and a fifth reflector 209b are respectively disposed below the second reflector 210a and the fourth reflector 210b. The second reflector 210a and the third reflector 209a guide the light generated by the first light source module 204a to enter the light guide 202. The fourth reflector 210b and the fifth reflector 209b guide the light generated by the second light source module 204b to enter the light guide 202. The reflective surface of the second reflector 210a faces the first cantilever 211a, and the reflective surface of the third reflector 209a faces the first reflector 206. The reflective surface of the fourth reflector 210b faces the second cantilever 211b, and the reflective surface of the fifth reflector 209b faces the first reflector 206. Furthermore, the second reflector 210a and the fourth reflector 210b respectively can be made to a double-sided reflective structure to replace the third reflector 209a and the fifth reflector 209b. The first cantilever 211a and the second cantilever 211b, by disposing a number of cantilever dot patterns 218b on the bottom of the cantilever, enable the evenly distributed light on the cantilever to be emitted. According to the present embodiment of the invention, in the absence of the first cantilever 211a and the second cantilever 211b, the width of light outputting surface equals A when the light generated by the light source module is mixed first and then directly emitted from the light guide 202. With the disposition of the first cantilever 211a and the second cantilever 211b, the light mixing zone becomes the first groove 208a and the second groove 208b, and the first cantilever 211a and the second cantilever 211b contribute to the increase in the light outputting surface of the light guide 202. The width B and the width B′ illustrated in the diagram are the increase in the width of the light outputting surface of the light guide 202.

### Second Embodiment

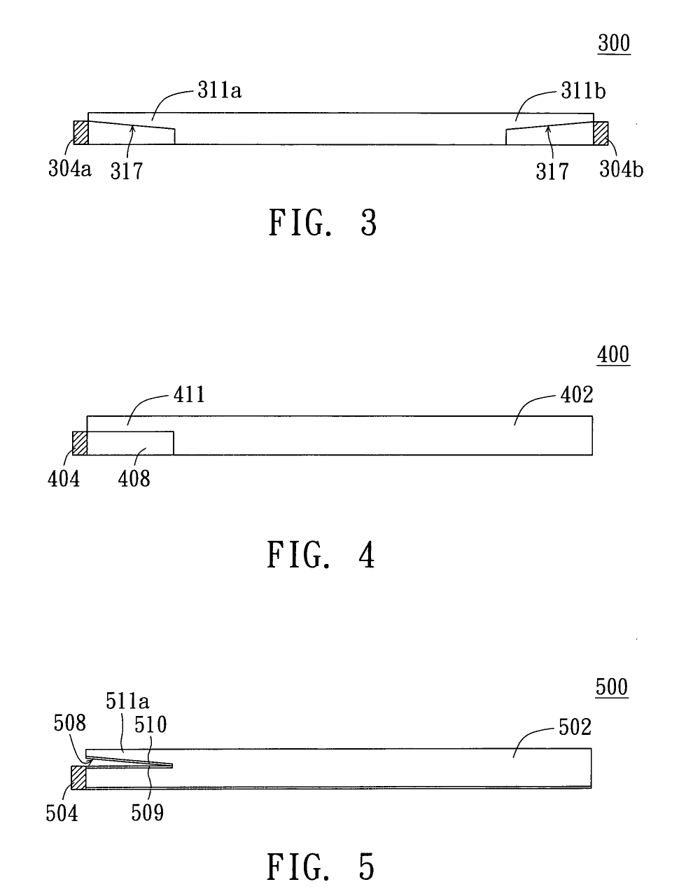

Referring to FIG. 3, a side view of the backlight structure according to a second embodiment of the invention is shown. The backlight structure has a first light source module 304a and a second light source module 304b. The present embodiment differs with the first embodiment in that the bottom surface 317 of the first cantilever 311a and that of the second cantilever 311b of the backlight structure 300 respectively are a bevel so as to achieve to achieve the same effect with the first embodiment. In the present embodiment, the disposition of the cantilever dot patterns is optional. The disposition of the cantilever dot patterns enables the light evenly distributed on the bevel to be emitted. In the absence of the disposition of the cantilever dot patterns, the light evenly distributed on the bevel can be emitted by adjusting the slope of the bevel.

### Third Embodiment

Referring to FIG. 4, a side view of the backlight structure according to a third embodiment of the invention is shown. The present embodiment differs with the first embodiment and the second embodiment in that the backlight structure 400 of the third embodiment only has a cantilever 411 disposed on the light guide 402. The present embodiment has the first light source module 404 disposed on one side or two sides of the backlight structure and mix the light in the first groove 408. After the mixed light enters the light guide 402, the evenly distributed light is emitted from the light guide 402.

### Fourth Embodiment

Referring to FIG. 5, a side view of the backlight structure according to a fifth embodiment of the invention is shown. The present embodiment differs with the first, the second and the third embodiment in that, in the backlight structure 500 of the fourth embodiment, the light guide 502 is directly extended to the first light source module 504 whose light is directly mixed in the light guide 502. In the present embodiment, the first cantilever 511a also has a bevel 508, forming a contained angle with the light guide 502. The second reflector 510 is disposed below the first cantilever 511a. The third reflector 509 is disposed on the light guide 502 positioned below the first cantilever 511a and forms a contained angle with the second reflector 510 as well. Meanwhile, an optical glue is further disposed between the first light source module 504 and the light guide 502 for the first light source module 504 to be directly connected to the light guide 502. By doing so, the light-mixing efficiency is further enhanced because less energy loss would occur when the light is being mixed in the air. Moreover, the light-mixing process is performed under the first groove 508 positioned below the cantilever, so the area of the light outputting surface of the light guide is increased like the first embodiment. Besides, the light guide 502 can be made by ejection molding method. Without increasing any extra manufacturing process, the object of enhancing the efficiency of the backlight and increasing the area of light outputting surface of the light guide can be achieved.

The backlight structure and the light guide disclosed in the above embodiments of the invention, according to the light guide having a cantilever structure, enable the area of the light outputting surface on the light guide to be equal to the sum of the area of the light guide body and the area of the cantilever. Compared with a conventional light guide without having a cantilever structure, the light guide of the invention increases a larger light outputting surface by the light-emitting area of the cantilever.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A backlight structure, comprising:
a light guide having a groove which is positioned on one side of the bottom of the light guide;
a first reflector disposed below the light guide and extended to the groove for a first light mixing zone to be formed within the groove; and
a light source module corresponding to the groove.

2. The backlight structure according to claim 1, wherein the light guide has a first cantilever formed above the groove.

3. The backlight structure according to claim 2, further comprising a second reflector disposed on the bottom of the first cantilever.

4. The backlight structure according to claim 3, wherein the second reflector has a double-sided reflective structure.

5. The backlight structure according to claim 3, further comprising a third reflector disposed below the second reflector, wherein the reflective surface of the second reflector faces the first cantilever, and the reflective surface of the third reflector faces the groove.

6. The backlight structure according to claim 2, wherein the bottom of the light guide and the first cantilever have a dot pattern formed thereon.

7. The backlight structure according to claim 2, wherein the first cantilever has a bevel.

8. The backlight structure according to claim 1, wherein the light source module comprises a plurality of light emitting diodes (LEDs).

9. A backlight structure, comprising:
a light guide having a first groove and a second groove which are respectively positioned on two sides of the bottom of the light guide;
a first reflector disposed below the light guide and extended to the first groove and the second groove for a first light mixing zone and a second light mixing zone to be formed within the first groove and the second groove, respectively;
a first light source module corresponding to the first groove and disposed the one side of the bottom of the light guide; and
a second light source module corresponding to the second groove and disposed on another side of the light guide.

10. The backlight structure according to claim 9, wherein the light guide has a first cantilever and a second cantilever respectively formed above the first groove and the second groove.

11. The backlight structure according to claim 10, further comprising a second reflector and a fourth reflector respectively disposed on the bottom of the first cantilever and the second cantilever.

12. The backlight structure according to claim 11, further comprising a third reflector and a fifth reflector respectively disposed below the second reflector and the fourth reflector, wherein the reflective surface of the second reflector faces the first cantilever, the reflective surface of the third reflector faces the first groove, the reflective surface of the fourth reflector faces the second cantilever, and the reflective surface of the fifth reflector faces the second groove.

13. The backlight structure according to claim 10, further comprising a plurality of dot patterns disposed on the bottom of the light guide, the first cantilever and the second cantilever.

14. The backlight structure according to claim 10, wherein the first cantilever and the second cantilever respectively have a bevel.

15. The backlight structure according to claim 9, wherein the firs light source module and the second light source module respectively comprise a plurality of LEDs.

16. The backlight structure according to claim 11, wherein the second reflector and the fourth reflector respectively have a double-sided reflective structure.

17. A backlight structure, comprising:
a light guide;
a light source module disposed on one side of the bottom of the light guide; and
a first reflector disposed in on the side the light guide adjacent to the first light source module and being substantially parallel to the incident direction of the light source module;
whereby a light mixing zone is formed in the internal space of the light guide having the first reflector.

18. The backlight structure according to claim 17, further comprising an optical glue filled between the light guide and the light source module.

19. The backlight structure according to claim 17, wherein the light guide has a cantilever.

20. The backlight structure according to claim 17, further comprising a second reflector disposed on the bottom of the first cantilever.

21. The backlight structure according to claim 20, further comprising a third reflector disposed below the second reflector, wherein a contained angle is formed between the second reflector and the third reflector.
